(19) United States
(12) Patent Application Publication
(10) Pub. No.: US 2015/0132446 A1
(43) Pub. Date: May 14, 2015

(54) SNACK-SIZE PET FOOD MIX

(71) Applicant: The Iams Company, Mason, OH (US)

(72) Inventor: Edward Russell Cox, Germantown, OH (US)

(21) Appl. No.: 14/540,957

(22) Filed: Nov. 13, 2014

Related U.S. Application Data
(60) Provisional application No. 61/903,604, filed on Nov. 13, 2013.

(51) Int. Cl. A23K 1/18; B65D 85/00

(52) U.S. Cl. CPC A23K 1/1853; B65D 85/70
USPC 426/120; 426/531; 426/635; 426/623; 426/641; 426/643

(57) ABSTRACT

An individually-packaged shelf-stable snack-sized pet food mix. The pet food mix includes at least two visually identifiable dried ingredients, wherein a total amount of about 5 grams to about 25 grams of the pet food mix is contained within the individual package and provides less than about 25% of the daily calories of the pet.

### FIELD OF THE INVENTION

The invention generally relates to a pet food mix, and more particularly, to a snack-sized pet food mix.

### BACKGROUND OF THE INVENTION

Many commercially available pet foods are designed to provide a complete diet that meets all of the pet's daily nutrition needs. These foods are typically available as dry crunchy kibble packaged in a bulk bag or as a wet gravy or pate mixture packaged in a single serving can, pouch, or tub.

Consumers often choose a cost-effective dry kibble as their pet's primary food source, and may also provide occasional treats, such as, for example, dry biscuits or moist chews available in bulk boxes or pouches. Because dry kibble and treats are generally multi-serve from bulk packaging, it can be difficult for pet owners to provide a customized meal or a variety of options without purchasing multiple bulk packages, and consumers will tend to serve the same dry kibble and treats for many meals in a row.

As such, there remains a need for convenient way to customize a pet meal. There also remains a need for a dried pet food mix that can be incorporated with dry kibble. In addition, there remains a need for a snack-sized pet food mix, such as, for example, a snack-sized pet food mix that is provided in individual easy-to-use unit dose containers.

### SUMMARY OF THE INVENTION

An individually-packaged shelf-stable snack-sized pet food mix is provided. The snack-sized pet food mix includes at least two visually identifiable dried ingredients. A total amount of about 5 grams to about 25 grams of the pet food mix is contained within the individual package and provides less than about 25% of the daily calories of the pet.

A multi-pack of individually-packaged shelf-stable snack-sized pet food mixes is also provided. The multi-pack contains a first individually-packaged snack-sized pet food mix having at least one first visually identifiable dried ingredient, wherein a total amount of about 5 grams to about 25 grams of the pet food mix is contained within the individual package and provides less than about 25% of the daily calories of the pet. The multi-pack also contains a second individually-packaged snack-sized pet food mix having at least two visually identifiable dried ingredients that are different from the first visually identifiable dried ingredient, wherein a total amount of about 5 grams to about 25 grams of the pet food mix is contained within the individual package and provides less than about 25% of the daily calories of the pet.

Further provided is a complete pet food diet including a first portion that is complete and balanced dry kibble and a second portion that is an individually-packaged snack-sized pet food mix of the present invention. The snack-sized pet food mix of the present invention preferably has at least two visually identifiable dried ingredients. Additionally, it is preferred that the snack-sized pet food mix has a total amount of about 5 grams to about 25 grams of the pet food mix within the individual package. In a preferred aspect, dry kibble provides more than about 75% of the daily calories of the pet and the snack-sized pet food mix of the present invention provides less than about 25% of the daily calories of the pet. In a further aspect, the snack-sized pet food mix of the present invention is adapted for mixing with dry kibble.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a photograph of array of snack-sized pet food mixes;

FIG. 2 is a photograph of a snack-sized pet food mix of the present invention when compared to dry kibble;

FIG. 3 is a photograph of the snack-sized pet food mix of the present invention mixed with dry kibble;

FIG. 4 is a photograph of the snack-sized pet food mix of the present invention with dehydrated chicken and beans;

FIG. 5 is a photograph of the snack-sized pet food mix of the present invention with dehydrated chicken and potatoes;

FIG. 6 is a photograph of the snack-sized pet food mix of the present invention with beef strips;

FIG. 7 is a photograph of the snack-sized pet food mix of the present invention with bacon and whole grains; and

FIG. 8 is a photograph of the snack-sized pet food mix of the present invention with beef and whole grains.

### DETAILED DESCRIPTION OF THE INVENTION

The present invention provides for a snack-sized pet food, which is described herein. The snack-sized pet food mix of the present invention preferably comprises small amounts of wholesome foods, such as, but not limited to, vegetables; meat or fish; whole grains; and/or fruit or other ingredients, in an individual dosing container. The wholesome foods can be in any suitable form, such as, but not limited to, dried, fresh, freeze-dried, powdered, moist, cooked, frozen, or any other suitable form, and can be whole, in pieces, or a powder. In some aspects, one or more of the ingredients is visually identifiable by a consumer, such as, but not limited to, ingredients that are unprocessed or minimally processed. The snack-sized pet food mix of the present invention preferably has visual, taste, and odor appeal for both the consumer and the pet and can provide for easy customization and variety of meals and treats.

In contrast to typical bulk packaging or meal-sized wet cans, the snack-sized pet food mix of the present invention is preferably packaged in small, individual snack-sized containers. Such containers are convenient and portable. The snack-sized pet food mix of the present invention can be available in a wide variety of flavors and ingredient combinations, and/or can be designed to provide synergistic or additive health and wellness benefits when served together or with a complete diet. As such, it is preferred that a consumer can purchase a variety of flavors and can easily select a flavor to mix with the pet's daily ration without having to store leftovers or waste unused product. In a preferred aspect, the snack-sized pet food mix contains an amount of food sufficient such that when it is mixed with a traditional pet diet, it comprises only a portion of a nutritionally complete meal. In another aspect, consumers can preferably select different flavors or different health benefits for each meal if desired. In some examples, a consumer can serve more than one individual snack-sized portion with each meal and can reduce the amount of the complete diet served accordingly.

The snack-sized pet food mixes of the present invention are preferably packaged in small individual containers. Preferably, the individual containers are between about 1 and 5 inches tall and about 1 and 5 inches in width. The container is not limited to a particular shape, as any shape that could adequately contain the snack-sized pet food mix would work for purposes of the present invention. In a preferred aspect, each individual container preferably can contain from about 5 to about 25 grams of pet food mix and can provide less than about 25% of the daily caloric needs of the pet. The snack-sized pet food mix can replace at least a portion of the pet's daily ration. In some examples, the pet can be served about the same total calories per day of the combined pet food mix and complete diet as the pet typically ingests of the complete diet alone.

The snack-sized pet food mixes of the present invention are preferably suitable for mixing with the pet's daily dry kibble or other complete diet, or can be served as a stand-alone treat or snack. In some examples, multiple snack-sized pet food mixes can be combined to provide a single complete meal for the pet in the absence of a complete food.

The snack-sized pet food mix can contain a single ingredient or more than one type of ingredient. In some aspects, the snack-sized pet food mix of the present invention contains meat, such as, but not limited to, beef, poultry, fish, or pork, along with one or more fruits, vegetables, or grains. In some aspects, the snack-sized pet food mix of the present invention does not contain meat. In an alternative aspect, the snack-sized pet food mix is vegetarian and does not contain any animal products like meat, eggs, or dairy products. Meatless or vegetarian mixes optionally can be combined with a meat snack-sized pet food mix for serving to the pet.

The snack-sized pet food mix of the present invention can be mixed with the pet's usual complete diet, such as, for example, a dry kibble. In some aspects, the snack-sized pet food mix can be designed with multiple size particles. Preferably, the snack-sized pet food mix having multiple size particles allow such particles to disperse on and throughout the spaces between the dried kibble when the snack-sized pet food mix is combined with dry kibble. Preferably, having multiple size particles helps distribution of the pet food mix within the dry kibble. In addition, in some aspects, the snack-sized pet food mix of the present invention has at least one color that contrasts with the color of dried kibble such that the snack-sized pet food mix can be visualized as it disperses throughout the dried kibble, when combined. In one embodiment, the snack-sized pet food mix can have a first ingredient that is a first color and a second ingredient that is a second, different color, where the first color and the second color are visually distinct from the color of the dried kibble.

As used herein, “pet” means dogs and cats, and/or other domesticated animals of like nutritional needs to a dog or a cat, such as, for example, minks and ferrets.

As used herein, the term “added” refers to an ingredient or element that is supplemented in a food, and excludes endogenous sources of the ingredient or element which are added for nutritive purposes. For example, a food free of added sugars may nonetheless contain sugars that are part of other food ingredients, such as fruits, vegetables, or grains.

As used herein, the term “artificial colorant” or “artificial color” or “artificial coloring” refers to colorants that are designated as such by regulation in the United States and or the European Union, such as, but not limited to, Blue 1, Blue 2, Citrus Red 2, Red 3, Red 40, Yellow 5, Yellow 6, and Green 3.

As used herein, unless otherwise stated for a particular parameter, the term “about” refers to a range that encompasses an industry-acceptable range for inherent variability in analyses or process controls, including sampling error. Consistent with the Model Guidance of AAFCO, inherent variability is not meant to encompass variation associated with sloppy work or deficient procedures, but, rather, to address the inherent variation associated even with good practices and techniques.

As used herein, the term “complete diet” refers a food which is a nutritionally adequate feed for an animal, is compounded to be fed as the sole ration, and is capable of maintaining life without any additional substance being consumed except water.

As used herein, the term “free of” refers to a product having less than 10 ppm of the specified element or additive, or, if the limit of detection for the specified element or additive is greater than 10 ppm, less than the limit of detection.

As used herein, “processed food” refers to a food which is significantly modified from its natural state, as by mechanical alteration (such as grinding or chopping), combination with other food products or additives, and/or cooking. As used herein, “processed food” excludes foods which substantially maintain their natural state after processing. For example, fresh produce may be washed, sorted, coated or treated, and packaged, but remain substantially in its natural state after processing, and would not be considered a “processed food” for the purpose of this disclosure.

As used herein, “minimally processed food” refers to a food that substantially maintains its natural state after processing. For example, fresh produce may be washed, sorted, coated or treated, and packaged, but remain substantially in its natural state after processing. Freezing, drying, canning, and fermenting are also considered minimal forms of processing. As used herein, “minimally processed food” includes perishable foods that may have added preservatives or that may be exposed to controlled amounts of heat or radiation to inactivate pathogens, such as, for example, pasteurized milk.

Unless otherwise described, all percentages are weight percent of the food on an as-fed basis.

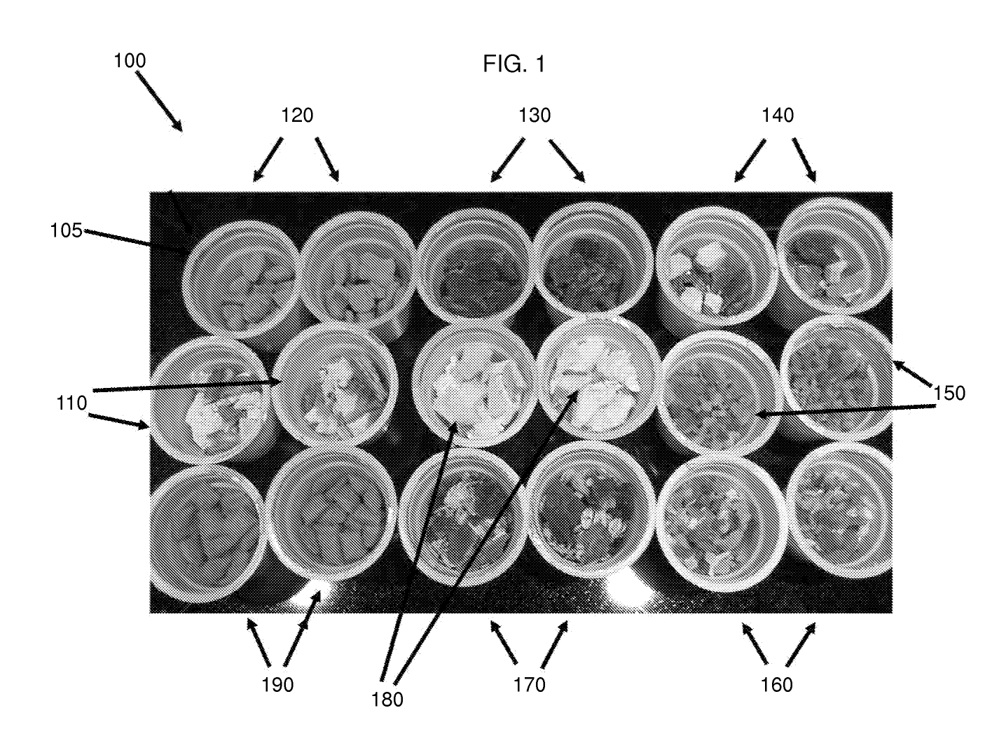

FIG. 1 shows an array 100 of snack-sized pet food mixes. Each snack-sized pet food mix is contained in an individual container 105. The array 100 includes two individual packages of a first snack-sized pet food mix 110 that contain dehydrated chicken and beans, two individual packages of a second snack-sized pet food mix 120 that contain moist meaty chunks, and two individual packages of a third snack-sized pet food mix 130 that contain dehydrated beef. The array 100 also contains two individual packages of a fourth snack-sized pet food mix 140 that contain dehydrated beef and vegetables, two individual packages of a fifth snack-sized pet food mix 150 that contain bacon, and two individual packages of a sixth snack-sized pet food mix 160 that contain bacon and whole grains. In addition, as shown in FIG. 1, the array 100 can also contain two individual packages of a seventh snack-sized pet food mix 170 that contains beef and whole grains, two individual packages of an eighth snack-sized pet food mix 180 that contain dehydrated chicken and potato, and two individual packages of a ninth snack-sized pet food mix 190 that contain chewy meaty pieces.

The array can contain any suitable number and type of size-sized food mixes, such as, for example, meat and vegetable mixes; vegetable only mixes; meat only mixes; fruit and vegetable mixes; meat, vegetable, and grain mixes; vegetable and grain mixes; or any other suitable combination of meat, vegetable, fruit, grain, or other suitable ingredients. In some examples, the array can contain mixes that include nutrients that promote health benefits, such as, for example, vitamins, minerals, antioxidants, or supplements, such as, for example, glucosamine, probiotics, or other suitable nutrients.

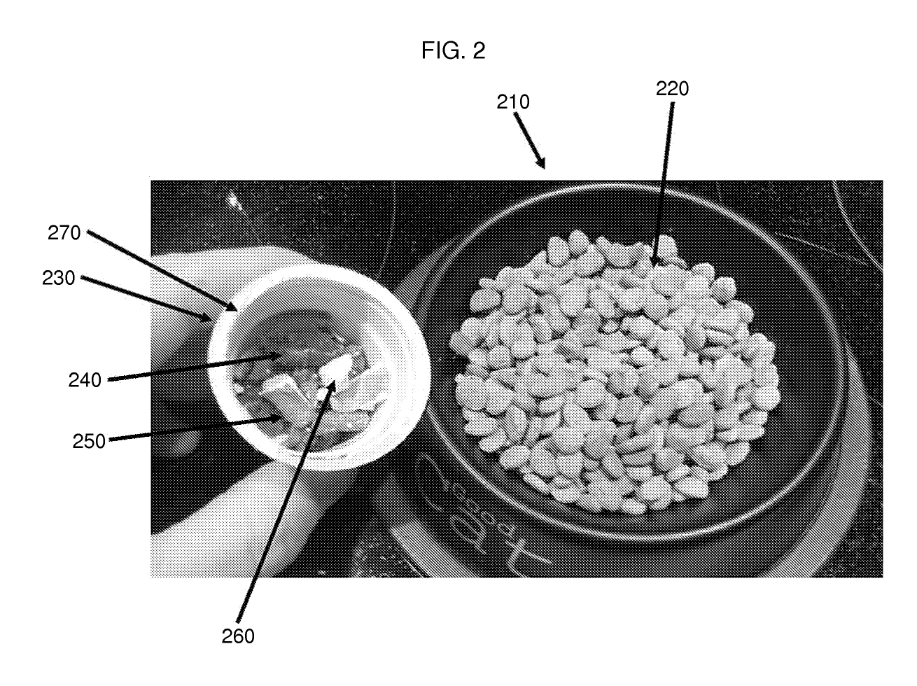

FIG. 2 shows a snack-sized pet food mix 230 in an individual container 270 and a bowl 210 of dry kibble 220. As shown in FIG. 2, the snack-sized pet food mix 230 can contain a meat 240, a vegetable 250, and a grain 260.

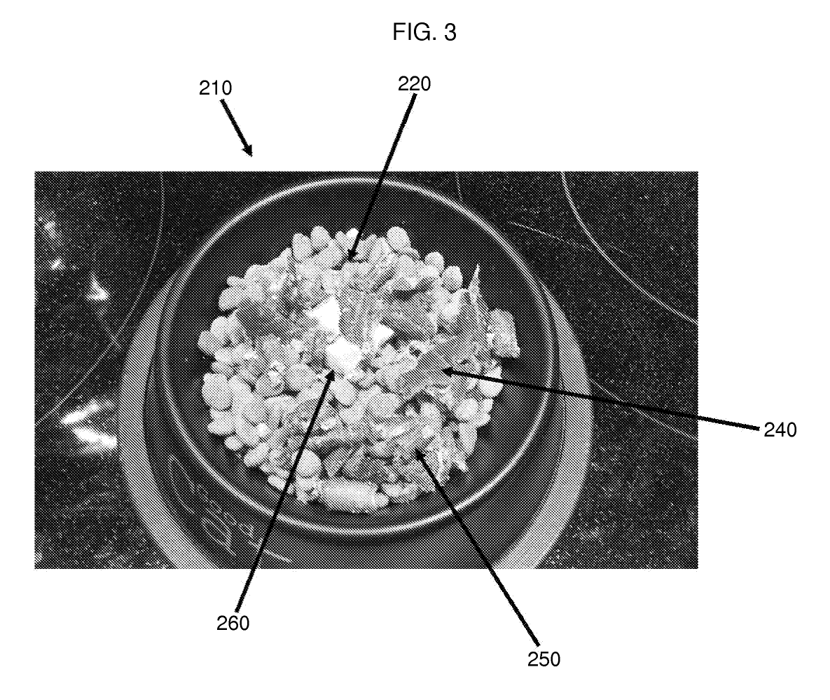

FIG. 3 shows the snack-sized pet food mix 230 and dry kibble 220 of FIG. 2 mixed together. As shown in FIG. 3, the meat 240, vegetable 250, and grain 260 components of the snack-size pet food mix 230 can incorporate throughout the dry kibble 220.

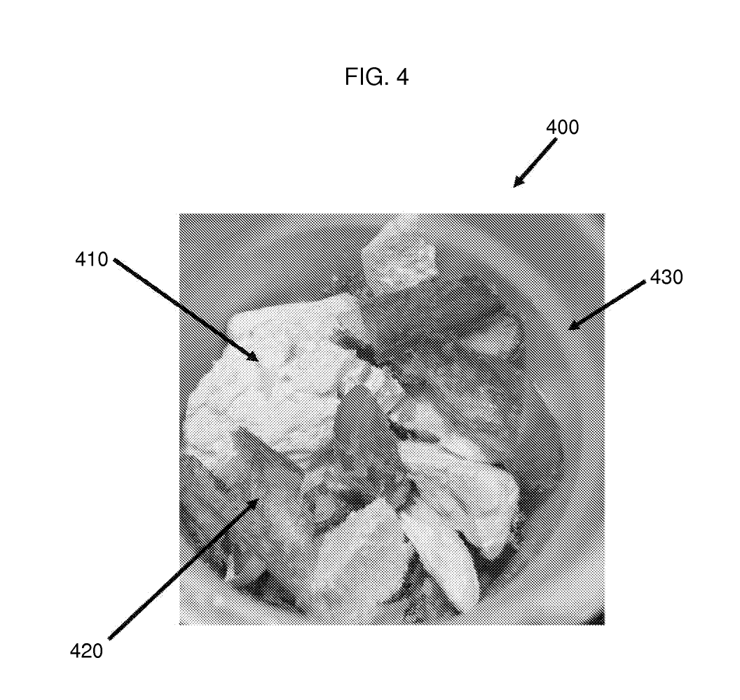

FIG. 4 shows a snack-sized pet food mix 400 in an individual container 430 that contains dehydrated chicken 410 and beans 420.

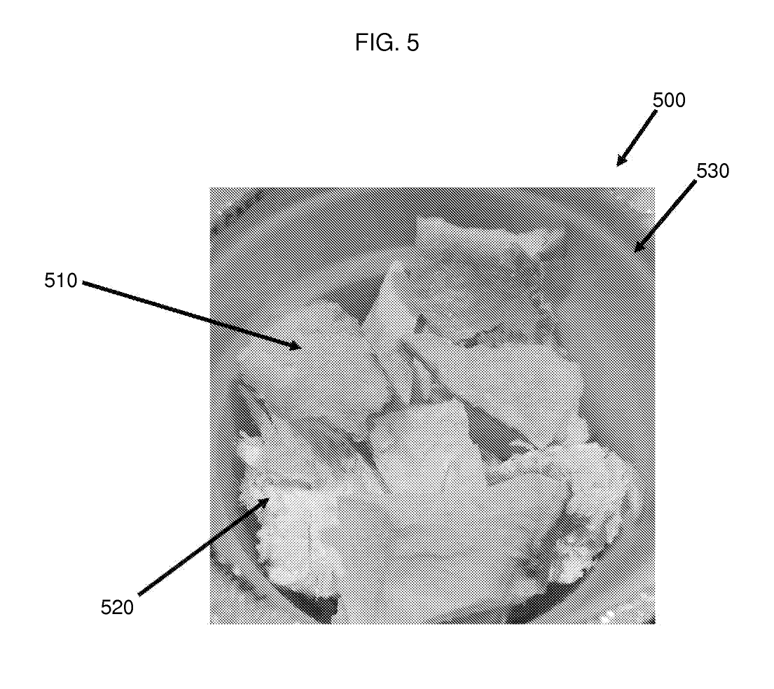

FIG. 5 shows a snack-sized pet food mix 500 in an individual container 530 with dehydrated chicken 520 and potatoes 510.

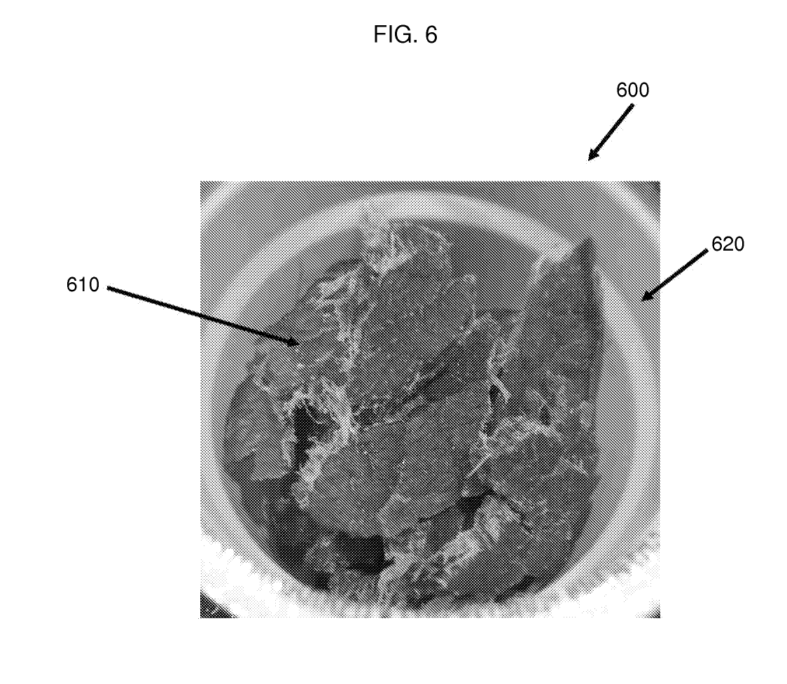

FIG. 6 shows a snack-sized pet food mix 600 in an individual container 620 with beef strips 610.

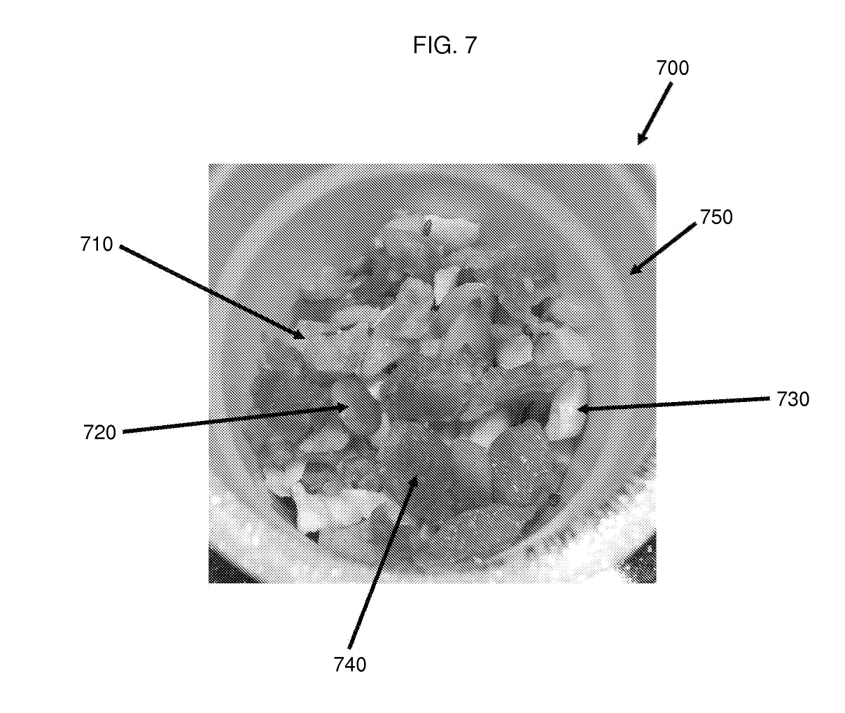

FIG. 7 shows a snack-sized pet food mix 700 in an individual container 750 with bacon 740 and whole grains 710, such as, for example, lentils 720 and oats 730.

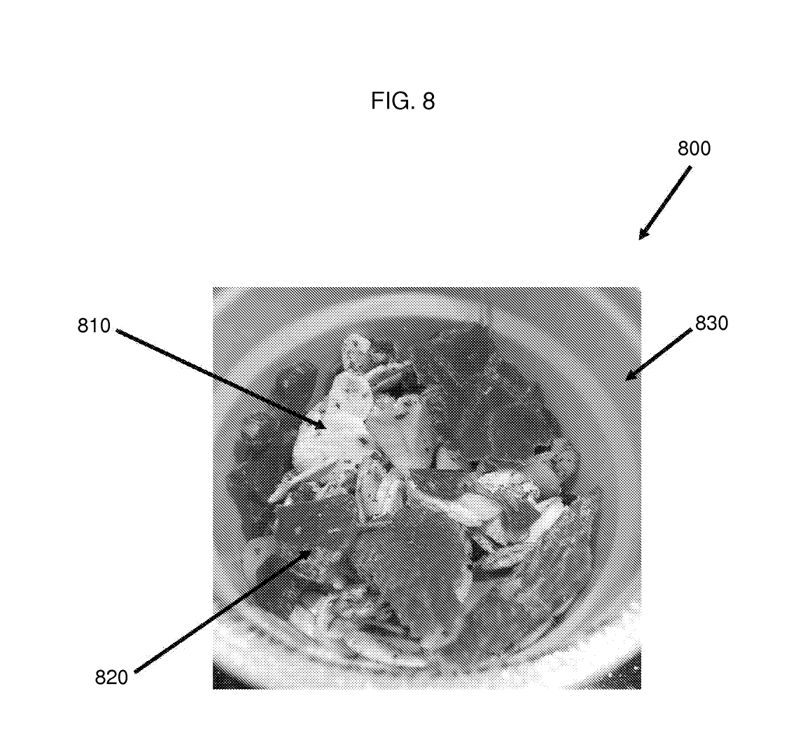

FIG. 8 shows a snack-sized pet food mix 800 in an individual container 830 with beef 820 and whole grains 810.

The snack-sized pet food can be contained in any packaging suitable for containing a single snack-sized portion, such as, for example, a cup, a pouch, a bag, or other suitable package or dispenser. In one example, the snack-sized pet food is contained in a single serving or dose cup. Such dose cups can be bundled together or can interlock. In addition, in one example, a variety of unit dose packs having different foods can be packaged together in a multi-pack. If desired, the multi-pack can contain an array of unit dose packs having different themes, such as, for example, a general health benefits or a flavors.

The individual packages can be any suitable size and shape, such as, but not limited to, containers that are between about 1 and 5 inches tall, about 1 and 5 inches in width, and about 1 and 5 inches in depth, such as, for example, between about 1 and 4 inches tall, about 1 and 3 inches tall, or about 1 and 2 inches tall; between about 1 and 4 inches wide, between about 1 and 3 inches wide, or about 1 and 2 inches wide; and between about 1 and 4 inches deep, between about 1 and 3 inches deep, or between about 1 and 2 inches deep. In examples where the individual packages have a diameter, the diameter can be between about 1 and 5 inches, such as, for example, between about 1 and 4 inches, about 1 and 3 inches, or about 1 and 2 inches in diameter.

The packaging can be any suitable configuration, such as, for example, an individual dosing cup with a removable lid, a pouch, a box, a can, or any other suitable configuration. In some examples, the lid can be peeled off from an opening in the container. The packaging can be any suitable material, such as, for example, plastic, paper, metal, or any other suitable material. Generally, the packaging will be adapted to facilitate safe handling of the pet food mix.

The packaging can be shelf-stable at room temperature. In addition, in some examples, the snack-sized pet food mix is not retort packaged or otherwise cooked or heated after packaging. Alternatively, the snack-sized pet food mix is retort packaged. In some examples, the packaging can be suitable for refrigeration and the snack-sized pet food can contain fresh ingredients.

Each individual container can contain any suitable amount of mix, such as, for example, from about 5 to about 25 grams of mix, such as, for example, from about 6 to about 23 grams of mix, from about 7 to about 20 grams of mix, from about 8 to about 18 grams of mix, and from about 10 to about 15 grams of mix. In some examples, the individual container can be adapted to contain a larger serving, such as, for example, for a large breed dog, and can contain from about 25 to about 75 grams of mix, such as, for example, from about 25 to about 50 grams of mix.

A single dose or serving of the snack-sized pet food mix can provide less than about 25% of the daily caloric needs of a pet, such as, for example, less than about 20% of the daily caloric needs, less than about 15% of the daily caloric needs, less than about 10% of the daily caloric needs, or less than about 5% of the daily caloric needs of a pet.

In some examples, the snack-sized pet food mix of the present invention contains from about 0.5 to about 25 calories per gram for a cat product, such as, for example, about 2.5 to about 15 calories per gram, or about 5 to about 10 calories per gram; or can contain from about 0.5 to about 100 calories per gram for a dog product, such as, for example, about 2 to about 75 calories per gram, about 5 to about 75 calories per gram, or about 10 to about 50 calories per gram. In some examples, the snack-sized pet food mix can contain less than about 450 calories per package for a dog, such as, for example, less than about 400, less than about 350, less than about 300, less than about 250, less than about 200, less than about 150, or less than about 100 calories per package; or can contain less than about 125 calories per package for a cat, such as, for example, less than about 100, less than about 75, less than about 50, or less than about 25 calories per package. In some examples, the snack-sized pet food mix can contain between about 50 and about 125 calories per package and can be suitable for both a cat and a dog.

In one aspect, the snack-sized pet food mix of the present invention can contain any suitable ingredients. In some examples, the snack-size pet food mix preferably contains ingredients that are unprocessed or minimally processed. In addition, or alternatively, the snack-size pet food mix of the present invention can contain ingredients such as vitamins, antioxidants, fiber, glucosamine, probiotics, or other suitable health-promoting ingredients.

In one aspect, the snack-sized pet food mix preferably contains one or more vegetables, such as, for example, peas, spinach, pumpkin, carrots, broccoli, celery, corn, soy, asparagus, brussel sprouts, cauliflower, cucumbers, beans, sweet potatoes, potatoes, okra, cabbage, beets, zucchini, avocados, or any other suitable vegetables.

In a further aspect, the snack-sized pet food mix of the present invention preferably contains one or more fruits, such as, for example, blueberries, cranberries, apples, tomatoes, grapefruits, oranges, pears, bananas, blackberries, cantaloupe, kiwis, raspberries, strawberries, watermelon, apricots, mangoes, pineapples, peaches, plums, or any other suitable fruit.

In an additional aspect, the snack-sized pet food mix of the present invention contains one or more meat or fish protein sources, such as, for example, poultry, such as, for example, chicken or turkey; beef; lamb; liver, pork, such as, for example, bacon or sausage; fish, such as, for example, tuna, mackerel, or sardines, or any other suitable meat or fish protein source.

The snack-sized pet food mix of the present invention preferably contains one or more vegetable or microbial protein sources, such as, for example, yeast, algae, or any other suitable protein source.

The snack-sized pet food mix of the present invention can contain one or more egg and/or dairy ingredients, such as, for example, dried egg, whole egg, yogurt, cheese, cottage cheese, or any other suitable egg or dairy ingredients.

The snack-sized pet food mix of the present invention preferably comprises whole grains, such as, for example, oats, brown rice, quinoa, amaranth, barley, millet, or any other suitable whole grain.

In some aspects, the snack-sized pet food mix of the present invention can be enriched with Vitamin E such that the food mix has a Vitamin E content of at least 80 IU/Kg of food mix, or at least 150 IU/Kg of food mix, or at least 250 IU/Kg of food mix, or at least 500 IU/Kg of food mix. In some embodiments, the food mix has a Vitamin C content of at least 10 ppm, or at least 25 ppm, or at least 50 ppm, or at least 100 ppm. Carotenoids, polyphenols, and/or other nutritive anti-oxidants may be used with or in lieu of Vitamins E and/or C.

The ingredients can be in any suitable form, such as, for example, dried, freeze-dried, powdered, moist, cooked, fresh, frozen, or any other suitable form, and can be whole, pieces, or powder. In some aspects, the snack-size pet food mixes can contain a variety of forms and sizes, which can facilitate distribution of the mix throughout the dry kibble. In addition, or alternatively, one or more of the ingredients is identifiable to a consumer. For example, a pet owner who opens an individual package containing green beans, oats, and chicken can visually identify one or more of the ingredients upon inspection.

An example formulation is shown in Table 1:

| | Amount per cup | % |
|---|---|---|
| Ingredient | (grams) | formulation |
| Vegetable blend | 4.8 | 30% |
| FOS | 1.6 | 10% |
| Lutein | 1.6 | 10% |
| Palatant | 5.6 | 35% |
| Vitamin E | 1.6 | 10% |
| Flax | 0.8 | 5% |

As shown in the Figures, in some examples, the snack-sized pet food mix preferably comprises one or more ingredients that is visually distinct in color from the dried kibble. Such contrast can allow the owner to visualize the mix being dispersed throughout the dried kibble. Contrast can be measured using a Hunter Color reflectance meter and the CIE LAB scale.

A complete technical description of the Hunter Color system can be found in an article by R. S. Hunter, ‘Photoelectric Color Difference Meter’, Journal of the Optical Society of America, Vol. 48, pp. 985-95, 1958. Devices specially designed for the measurement of color on the Hunter scales are described in U.S. Pat. No. 3,003,388 to Hunter et al., issued Oct. 10, 1961. In general, Hunter Color “L” scale values are units of light reflectance measurement, and the higher the value is, the lighter the color is since a lighter colored material reflects more light. In particular, in the Hunter Color system the “L” scale contains 100 equal units of division. Absolute black is at the bottom of the scale (L=0) and absolute white is at the top of the scale (L=100).

Colors can be measured according to the CIE LAB system, which is similar to Hunter L, a, b and is based on three dimensions, specifically L*, a*, and b*.

When a color is defined according to this system L* represents lightness (0=black, 100=white), a* and b* independently each represent a two color axis, a* representing the axis red/green (+a=red, −a=green), while b* represents the axis yellow/blue (+b=yellow, −b=blue).

Differences between colors may be identified by a ΔE value, which is mathematically expressed by the equation:

ΔE*=[(L*_{X•}−L*_{Y})²+(a*_{X•}−a*_{Y})²+(b*_{X}−b*_{Y})²]^{1/2}

‘X’ represents the standard or reference sample which may either be a ‘white’ sample or a ‘colored’ sample, e.g., one color may be compared to another color.

Testing can be conducted using a Lab Scan XE 45/0 geometry instrument in accordance with method ASTM E 1164-94, “Standard Practice for Obtaining Spectrophotometric Data for Object-Color Evaluation”. Sample color can be reported in terms of the CIE 1976 color coordinate standard as specified in ASTM E 1164-94 and ASTM D2264-93, section 6.2. This consists of three values; L* which measures sample “lightness”, a* which measures redness or greenness, and b* which measures yellowness or blueness.

Generally, the dry kibble and the measured component of the snack-sized pet food mix can have a ΔE≧3.5, such as, for example, a ΔE≧5 or a ΔE≧8.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

For purposes of the invention, the terms “comprising”, “consisting essentially of”, and “consisting of” are all given their ordinary meaning, where terms such as including also mean comprising. It is meant that these terms are used interchangeably throughout the application. Thus, as a non-limiting example, where the application states that, “the snack-sized pet food mix of the present invention preferably comprises whole grains” this should be interpreted that the “comprising” language could also be interchanged with “consisting essentially of” and/or “consisting of”. Therefore, this passage also supports a claim limitation of “the snack-sized pet food mix of the present invention preferably consists essentially of whole grains,” as well as “the snack-sized pet food mix of the present invention preferably consists of whole grains,” and “the snack-sized pet food mix of the present invention preferably comprises whole grains.”

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An individually-packaged shelf-stable snack-sized pet food mix comprising at least two dried ingredients, wherein a total amount of about 5 grams to about 25 grams of the pet food mix is contained within the individual package and provides less than about 25% of the daily calories of the pet.

2. The pet food mix of claim 1, wherein the at least two dried ingredients are selected from the group consisting of: a vegetable, a fruit, a grain, and combinations thereof.

3. The pet food mix of claim 1, wherein at least one of the dried ingredients is a meat or fish.

4. The pet food mix of claim 3, wherein at least one of the dried ingredients is a vegetable or a fruit.

5. The pet food mix of claim 1, wherein the ingredients are minimally processed.

6. The pet food mix of claim 1, wherein the ingredients are visually distinct in size.

7. The pet food mix of claim 1, wherein the pet food mix further includes at least one powdered ingredient.

8. The pet food mix of claim 1, wherein the pet food mix is not cooked or heated after packaging.

9. A multi-pack of individually-packaged shelf-stable snack-sized pet food mixes, the multi-pack containing:
a. a first individually-packaged snack-sized pet food mix having at least one first dried ingredient, wherein a total amount of about 5 grams to about 25 grams of the pet food mix is contained within the individual package and provides less than about 25% of the daily calories of the pet; and
b. a second individually-packaged snack-sized pet food mix having at least two dried ingredients that are different from the first visually identifiable dried ingredient, wherein a total amount of about 5 grams to about 25 grams of the pet food mix is contained within the individual package and provides less than about 25% of the daily calories of the pet.

10. The multi-pack of claim 9, wherein the first pet food mix contains a meat or fish and the second pet food mix contains a fruit or vegetable.

11. The multi-pack of claim 9, wherein the ingredients are minimally processed.

12. The multi-pack of claim 9, wherein the pet food mixes further includes at least one powdered ingredient.

13. The multi-pack of claim 9, wherein the pet food mixes are not cooked or heated after packaging.

14. A complete pet food diet comprising a first portion that is complete and balanced dry kibble and a second portion that is an individually-packaged snack-sized pet food mix having at least two dried ingredients, wherein a total amount of about 5 grams to about 25 grams of the pet food mix is contained within the individual package, wherein the dry kibble provides more than about 75% of the daily calories of the pet and the snack-sized pet food mix provides less than about 25% of the daily calories of the pet, and wherein the dry kibble and the snack-sized pet food mix being adapted for mixing together.

15. The complete pet food diet of claim 14, wherein the dried ingredients are selected from the group consisting of: a vegetable, a fruit, a grain, and combinations thereof.

16. The complete diet of claim 14, wherein the ingredients are minimally processed.

17. The complete diet of claim 14, wherein the ingredients are visually distinct in size.

18. The complete diet of claim 14, wherein the pet food mix further includes at least one powdered ingredient.

19. The complete diet of claim 14, wherein the pet food mix is not cooked or heated after packaging.

20. The complete diet of claim 14, wherein the pet food mix is visually distinct from the dry kibble.
